(19) United States
(12) Patent Application Publication
(10) Pub. No.: US 2010/0060233 A1
(43) Pub. Date: Mar. 11, 2010

(54) Charger with USB detection

(76) Inventors: Nien-Hui Kung, Hsinchu City (TW); Chun-Tsung Chen, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/585,069

(22) Filed: Sep. 2, 2009

(30) Foreign Application Priority Data
Sep. 8, 2008 (TW) 097134463

(51) Int. Cl. H02J 7/00; G06F 1/00

(52) U.S. Cl. 320/107; 713/300

(57) ABSTRACT

A charger for a battery system detects the voltage level of a data pin of the battery system to determine whether an external power source plugged in to the battery system is a USB voltage source. When the external power source is a USB voltage source, the charger will provide power for a USB transceiver of the battery system or enable it.

### FIELD OF THE INVENTION

The present invention is related generally to a battery system and, more particularly, to a charger with USB detection.

### BACKGROUND OF THE INVENTION

Currently, the lithium-ion battery systems in portable electronic devices can be charged through the universal serial bus (USB) sockets on computers or hosts, in addition to be charged by alternating current (AC) power sources. However, the majority of portable electronic devices use a single power input pin for receiving power from an AC power source and a USB voltage source. Therefore, the battery systems must be capable of identifying the power input type of the connected power source to the power input pin. If the connected power source is an AC power source, the battery system only charges the lithium-ion battery thereof. If the connected power source is a USB voltage source, data transmission can be performed in addition to battery charging.

U.S. Pat. No. 6,957,292 to Croyle proposed a USB circuit which detects the connection status to a USB host by using a USB transceiver. However, this art requires the USB transceiver always at detecting state, and thereby results in significant power loss.

Therefore, it is desired a solution for identifying the power input type with reduced power loss.

### SUMMARY OF THE INVENTION

An object of the present invention is to provide a battery system and a control method thereof.

Another object of the present invention is to provide a charger for a battery system.

According to the present invention, a battery system comprises a power input pin to be connected with an external power source, a USB transceiver for data exchange with a host through a first data pin and a second data pin, and a charger which detects the voltage level of one of the first data pin and second data pin to determine whether the external power source is a USB voltage source. If the external power source is a USB voltage source, the USB transceiver will be enabled; otherwise the USB transceiver will not turn on. The charger comprises a detector to detect the voltage level of the one of the first data pin and second data pin to determine whether the external power source is a USB voltage source, and a controller to enable the USB transceiver if the external power source is verified by the detector as a USB voltage source.

### BRIEF DESCRIPTION OF THE DRAWINGS

These and other objects, features and advantages of the present invention will become apparent to those skilled in the art upon consideration of the following description of the preferred embodiments of the present invention taken in conjunction with the accompanying drawings, in which:

FIG. 1 is a diagram showing a lithium-ion battery system according to the present invention in connection with a host;

FIG. 2 is a flowchart of an operation process of the charger shown in FIG. 1;

FIG. 3 is a diagram of another embodiment for the charger shown in FIG. 1; and

FIG. 4 is a flowchart of a control method according to the present invention.

### DETAILED DESCRIPTION OF THE INVENTION

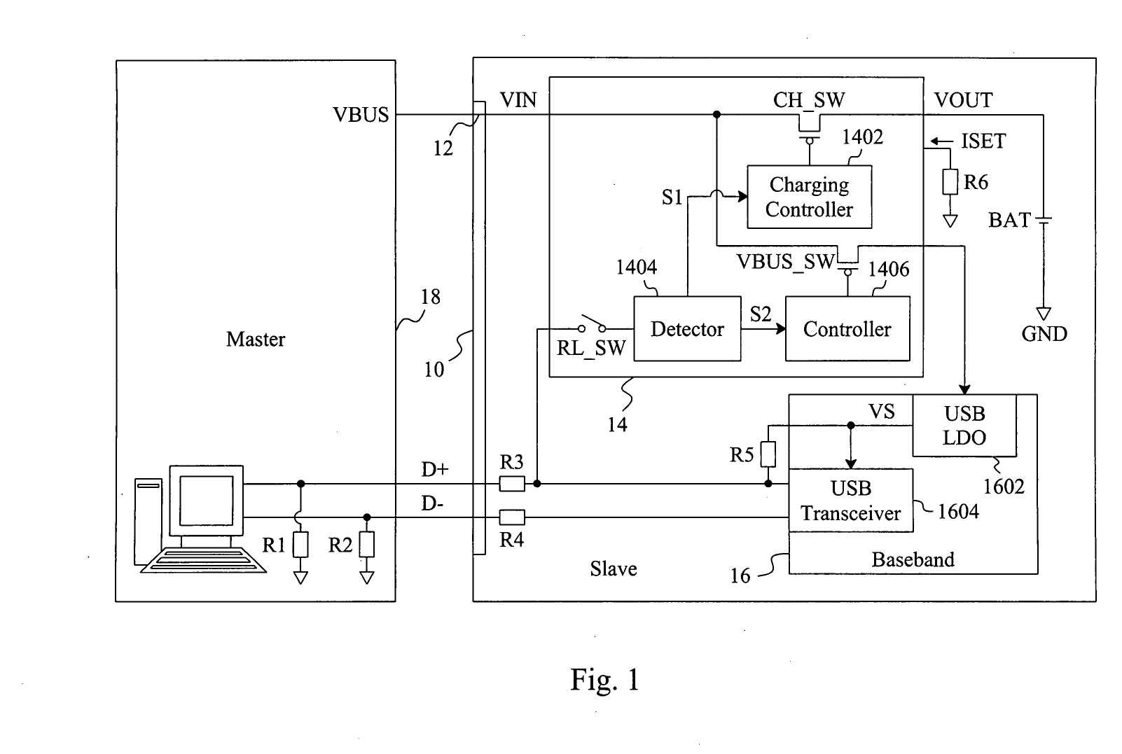

As shown in FIG. 1, a lithium-ion battery system 10 has a power input pin 12 to be connected with an external power source, a charger 14 connected between the power input pin 12 and a lithium-ion battery BAT to charge the battery BAT, and a baseband chipset 16 connected to the data pins D+ and D− of a USB interface for data exchange with an external circuit. The charger 14 includes a power input terminal VIN connected to the power input pin 12, a power transistor CH_SW connected between the power input terminal VIN and the battery BAT, a charging controller 1402 connected to the gate of the power transistor CH_SW to control the charging current to the battery BAT according to a control signal S1, a USB detector 1404 to provide the control signal S1, a switch RL_SW connected between the USB detector 1404 and the data pin D+ such that during the switch RL_SW is closed, the USB detector 1404 may detect the voltage level of the data pin D+ to determine whether the external power source is a USB voltage source and accordingly the control signals S1 and S2, a power transistor VBUS_SW connected between the power input terminal VIN and the baseband chipset 16, and a controller 1406 connected to the gate of the power transistor VBUS_SW to control power provided for the baseband chipset 16 according to the control signal S2. Alternatively, the USB detector 1404 may detect the voltage level of the data pin D− or the voltage levels of both the data pins D+ and D− to determine whether the external power source is a USB voltage source. The baseband chipset 16 includes a USB transceiver 1604 connected to the data pins D+ and D− for data exchange with the external circuit when a host 18 is plugged in, and a USB low-dropout (LDO) regulator 1602 to convert the supplied voltage from the charger 14 into a regulated voltage VS for the USB transceiver 1604.

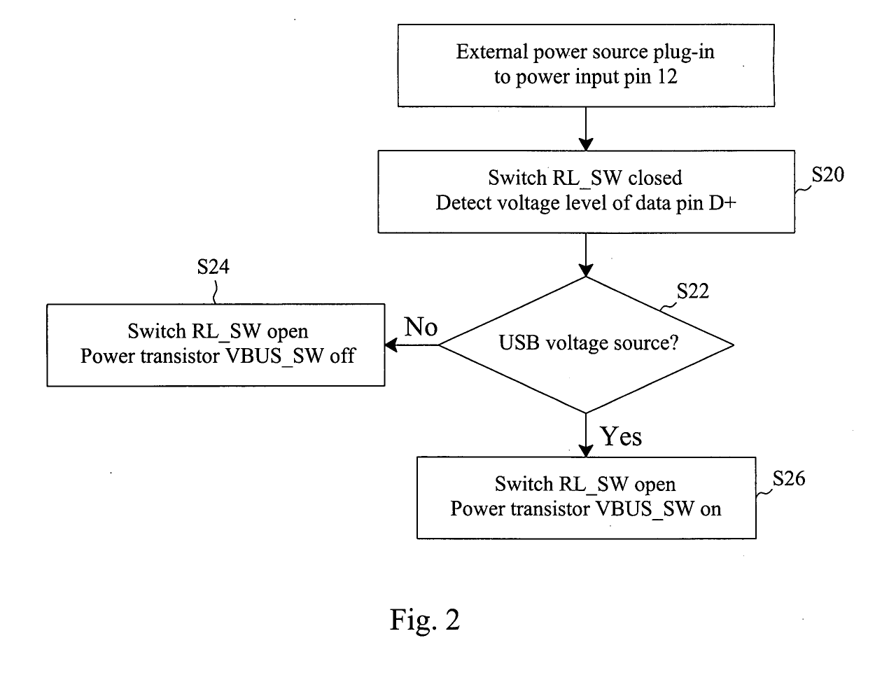

FIG. 2 is a flowchart of an operation process of the charger 14 shown in FIG. 1. In response to a plug-in of a power input to the power input pin 12, the switch RL_SW is closed for the USB detector 1404 to detect the voltage level of the data pin D+ in step S20, and according to the voltage level of the data pin D+, in step S22, the USB detector 1404 determines whether the external power source plugged in to the power input pin 12 is a USB voltage source. If the external power source is not a USB voltage source, it will go to step S24, in which the switch RL_SW is open and the power transistor VBUS_SW is off. In this case, the battery BAT is charged by the external power source according to a current setting ISET. On the contrary, if the external power source is a USB voltage source, it will go to step S26, in which the switch RL_SW is open and the power transistor VBUS_SW is on. In this case, the charger 14 allows the supply voltage VBUS from the host 18 to the USB LDO 1602 and thereby provides power for the chipset 16, and the USB LDO 1602 provides the regulated voltage VS for the USB transceiver 1604. In addition, the charger 14 charges the battery BAT with a preset USB charging current (about 450 mA). Alternatively, when the external power source is a USB voltage source, the controller 1406 will control the power transistor VBUS_SW to thereby convert the voltage VIN into the voltage VS to directly provide for the USB transceiver 1604.

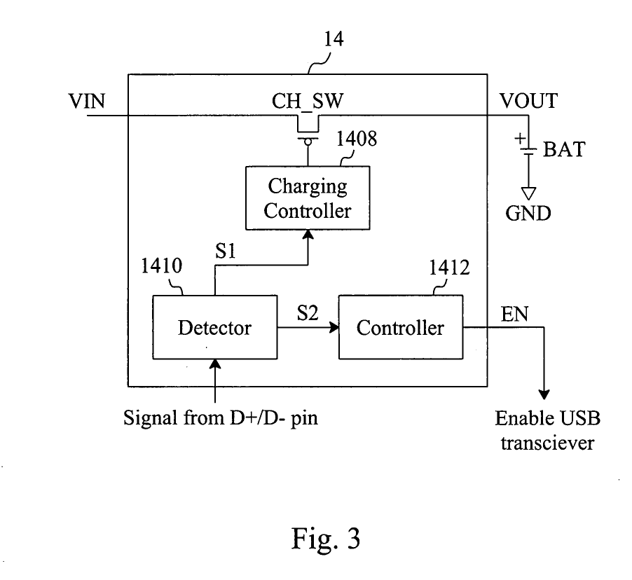

FIG. 3 is a diagram of another embodiment for the charger 14 shown in FIG. 1, which includes a power transistor CH_SW connected between the power input terminal VIN and battery BAT, a charging controller 1408 connected to the gate of the power transistor CH_SW to control the charging current to the battery BAT according to the control signal S1 provided by the USB detector 1410, and a controller 1412 connected to the USB detector 1410 to assert an enable signal for the USB transceiver 1604 according to the control signal S2. When the USB detector 1410 detects a USB voltage source plugged in, it will trigger the control signal S2 and accordingly, the controller 1412 will enable the USB transceiver 1604. On the contrary, if the external power source is not a USB voltage source, the controller 1412 will not enable the USB transceiver 1604.

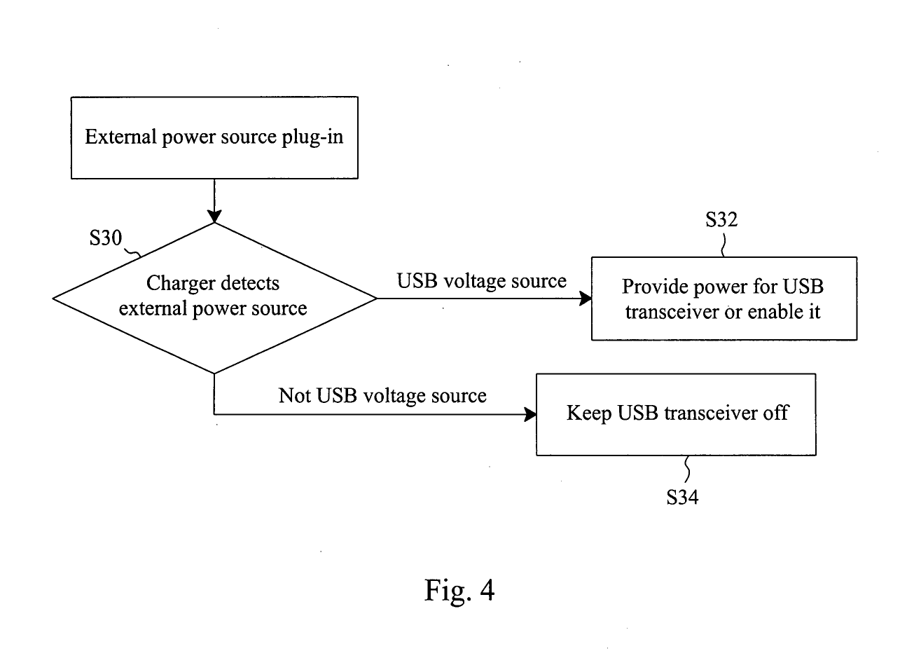

FIG. 4 is a flowchart of a control method according to the present invention. In response to an external power source plug in, the charger 14 detects the external power source to determine whether it is a USB voltage source in step S30. If the external power source is a USB voltage source, it will go to step S32, in which the charger 14 will provide power for the USB transceiver 1604 or enable the USB transceiver 1604. If the external power source is not a USB voltage source, it will go to step S34, in which the charger 14 will not provide power for the USB transceiver 1604 or disable the USB transceiver 1604.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A charger for a battery system including a power input pin to be connected with an external power source, and a USB transceiver for data exchange with an external circuit through a first data pin and a second data pin, the charger comprising:
a detector connected to one of the first data pin and second data pin to detect the voltage level thereon to determine whether the external power source is a USB voltage source; and
a controller connected to the detector to control to provide power for the USB transceiver when the detector determines that the external power source is a USB voltage source.

2. The charger of claim 1, wherein the first data pin is a USB D+ pin and the second data pin is a USB D− pin.

3. A charger for a battery system including a power input pin to be connected with an external power source, and a USB transceiver for data exchange with an external circuit through a first data pin and a second data pin, the charger comprising:
a detector connected to one of the first data pin and second data pin to detect the voltage level thereon to determine whether the external power source is a USB voltage source; and
a controller connected to the detector and USB transceiver to enable the USB transceiver when the detector determines that the external power source is a USB voltage source.

4. The charger of claim 3, wherein the first data pin is a USB D+ pin and the second data pin is a USB D− pin.

5. A battery system, comprising:
a power input pin for being connected with an external power source;
a USB transceiver for data exchange with an external circuit through a first data pin and a second data pin; and
a charger connected to one of the first data pin and second data pin to detect the voltage level thereon to determine whether the external power source is a USB voltage source.

6. The battery system of claim 5, further comprising an internal voltage source connected to the charger and USB transceiver to provide power for the USB transceiver.

7. The battery system of claim 6, wherein the charger comprises:
a detector connected to the one of the first data pin and second data pin to detect the voltage level thereon to determine whether the external power source is a USB voltage source; and
a controller connected to the detector and internal voltage source to provide power for the USB transceiver when the detector determines that the external power source is a USB voltage source.

8. The battery system of claim 5, wherein the first data pin is a USB D+ pin and the second data pin is a USB D− pin.

9. A control method for a battery system including a power input pin to be connected with an external power source, a USB transceiver for data exchange with an external circuit through a first data pin and a second data pin, and a charger connected to the power input pin to charge a battery in the battery system, the control method comprising the steps of:
in response to a plug-in of an external power source to the battery system, detecting the voltage level of one of the first data pin and second data pin by the charger to determine whether the external power source is a USB voltage source; and
enabling the USB transceiver if the external power source is a USB voltage source.

10. The control method of claim 9, wherein the step of enabling the USB transceiver comprises providing power for the USB transceiver.

11. The control method of claim 9, wherein the first data
pin is a USB D+ pin and the second data pin is a USB D− pin.
